(19) United States
(12) Patent Application Publication
(10) Pub. No.: US 2009/0272036 A1
(43) Pub. Date: Nov. 5, 2009

(54) DOOR STORAGE DEVICE

(76) Inventor: James Matthew Stephens, Cincinnati, OH (US)

Correspondence Address: MCDONALD HOPKINS LLC, 600 Superior Avenue, East, Suite 2100, CLEVELAND, OH, 44114-2653, US

(21) Appl. No.: 12/435,826

(22) Filed: May 5, 2009

Related U.S. Application Data
(60) Provisional application No. 61/126,476, filed on May 5, 2008.

(51) Int. Cl. E06B 7/00

(52) U.S. Cl. 49/70

(57) ABSTRACT

The present invention is directed to a door storage device. The door storage device 10 includes a body 15 having a first leg 20 and a second leg 22 extending therefrom. At least one protrusion 25 extends outwardly from at least one of the first leg 20 or second leg 22. The first leg 20 and second leg 22 each include one or more contact portions 30, 35. The door storage device 10 is capable of being placed on the top portion of a door.

### FIELD OF THE INVENTION

The present invention generally relates a door storage device.

### BACKGROUND OF THE INVENTION

Showers and bathtubs are often provided with shelves or indentations for storing items such as soap, shampoo, and the like. To provide additional storage space, users often attach racks or hangers to the showerhead itself. Such hangers typically suffer a variety of deficiencies. For example, hangers for use with showerheads easily become unbalanced as items are either placed on or taken from them. Further, such hangers do not provide storage space for dry items such as towels.

Accordingly, there is a need for an improved door storage device. In addition, there is a need for a door storage device that provides storage space for items inside and outside of a bathtub or shower. Additional information will be set forth in the description that follows, or may be learned by practicing the teachings set forth in the description.

### DESCRIPTION OF THE DRAWINGS

The preferred embodiments may be better understood by reference to the following illustrations:

FIG. 1A illustrates a preferred embodiment of a door storage device;

FIG. 1B illustrates a side view of the door storage device of FIG. 1A;

FIG. 1C illustrates a perspective view of the door storage device of FIG. 1A;

FIG. 2 illustrates a preferred embodiment of a door storage device;

FIG. 3 illustrates a preferred embodiment of a door storage device;

FIG. 4 illustrates a preferred embodiment of a door storage device;

FIG. 5 illustrates a preferred embodiment of a door storage device; and

FIG. 6 illustrates a preferred embodiment of a door storage device.

### DETAILED DESCRIPTION OF THE PREFERRED EMBODIMENTS

While the present invention is described with reference to embodiments described herein, it should be clear that the present invention is not limited to such embodiments. Therefore, the description of the embodiments herein is merely illustrative of the present invention and will not limit the scope of the invention as claimed.

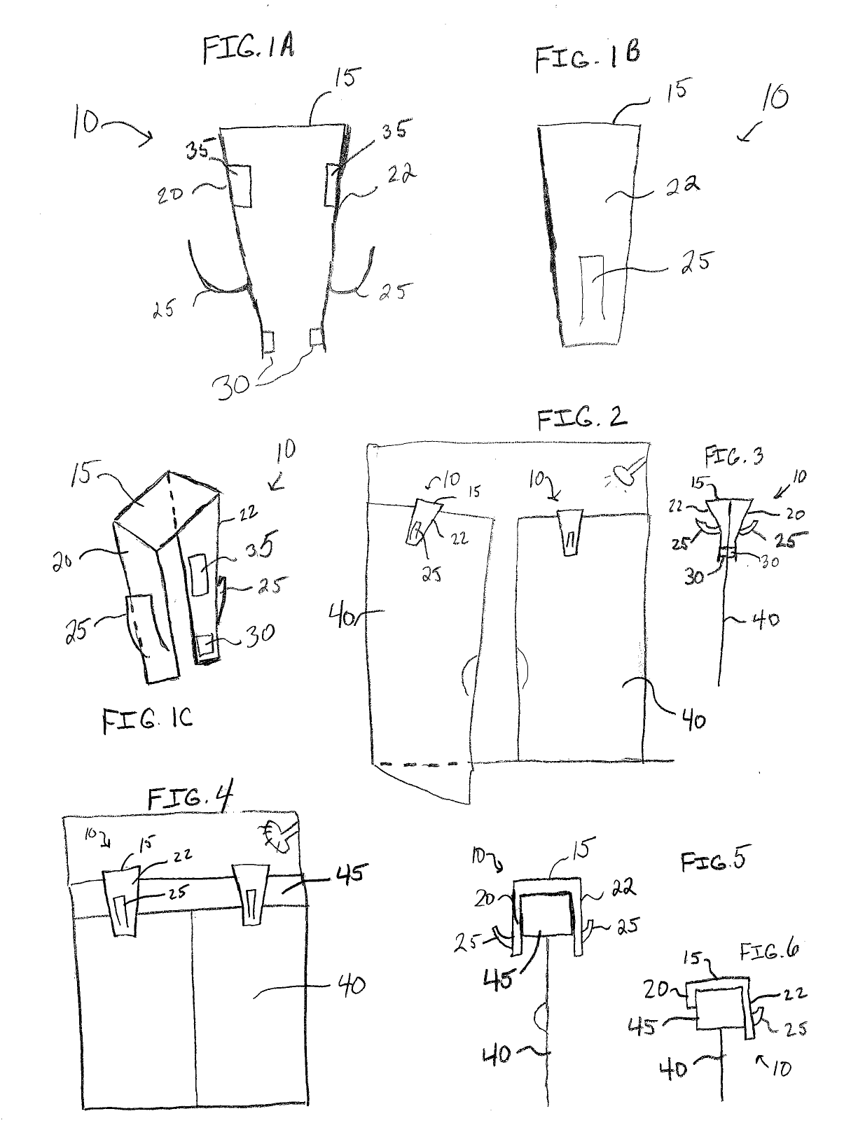

Reference will now be made in detail to the accompanying figures. As shown in FIG. 1, the present door storage device 10 (hereinafter referred to as “the device 10”) may include a body 15, one or more legs 20, 22, and one or more protrusions 25. The device 10 may also include one or more contact portions 30, 35.

As best shown in FIGS. 1A-C, the device 10 is provided with a body 15 having a first leg 20 and a second leg 22 extending therefrom. The legs 20 and 22 may be oriented to engage an object, such as a shower door 40 or railing 45, as shown in FIGS. 2-6. It is to be understood that the body 15 and legs 20, 22 may be made from any material including, but not limited to, plastic, metal, composites, wood, and the like. Further, although shown as substantially the same length, it is to be understood that the legs 20, 22 may have different lengths.

As shown in FIG. 1A, the legs 20, 22 may be provided with one or more contact portions 30, 35 for engaging the surface of a shower door 40 or railing 45. In a non-limiting example, the contact portion 30 may be any material capable of gripping the shower door 40 or railing 45 without scratching the shower door 40 or railing 45. In a non-limiting example, the contact portions 30, 35 may be a material such as rubber or foam.

It is to be understood that the legs 20, 22 may be provided with one or more protrusions 25 extending from the legs 20, 22 for hanging or otherwise storing items such as towels, washcloths, hangars, organizers, and the like. Although shown as substantially hook shaped, one of ordinary skill in the art will appreciate that the protrusions 25 may be provided in a variety of shapes. The protrusions 25 may be removeably secured to the legs 20, 22, allowing for a variety of positions or configurations. For example, the legs 20, 22 may be provided with one or more apertures (not shown) capable of removeably securing one or more protrusions 25 therein.

As shown in FIGS. 2 and 3, the device 10 may be removeably secured to a shower door 40. As shown in FIG. 3, the device 10 may be inserted over the door 40 such that the contact portions 30 engage the opposing sides of the door 40. As shown in FIG. 3, the body 15 may rest on the top of the door 40. In a non-limiting example, the body 15 may be provided with a groove or recess (not shown) capable of receiving the top of the door 40 therein. Such a configuration may provide additional stability to the device 10. Accordingly, the device 10 may provide a protrusion 25 inside the shower or bath area, and a protrusion 25 outside of the shower or bath area. Therefore, a person may secure an item, such as a towel, to the protrusion 25 extending from the leg 22 to keep the item dry while bathing or showering.

As shown in FIGS. 4 and 5, the device 10 may also be secured, to for example, a railing 45. It is to be understood that the railing 45 may be for a door 40, or for a shower curtain (not shown). As best shown in FIG. 5, the device 10 may be positioned about the railing 45 such that the legs 20, 22 engage opposite sides of the railing 45. Although not shown, it is understood that contact portions 35 may be provided for engaging the sides of the railing 45. Further, it is to be understood that the body 15 and legs 20, 22 may be shaped to be secured to a variety of shapes of railings. In a non-limiting example, the device 10 may be shaped to be secured to a cylindrical railing. Accordingly, items that must remain dry, such as a towel, may be removeably secured to the protrusion 25 extending from the leg 22.

As shown in FIG. 6, the device 10 may be provided with a single protrusion 25 and the leg 20 may be shorter than the leg 22. It is to be understood that the device 10 may be provided in a variety of different configurations. Further, it is to be understood that the device 10 is not limited to shower doors and railings, but may be used on any type of door or railing.

The invention has been described above and modifications and alternations will occur to others upon a reading and understanding of this specification. The claims as follows are intended to include all such modifications and alterations insofar as they come within the scope of the claims or the equivalent thereof.

Having thus described the invention, what is claimed is:

1. A door storage device comprising:
a body having a first leg and a second leg extending therefrom to form a generally U-shape;
at least one protrusion extending outwardly from at least one of said first leg and second leg; and
at least one contact portion extending inwardly from said first and second legs.

2. The door storage device of claim 1, wherein the length of said first leg is equal to the length of said second leg.

3. The door storage device of claim 1, wherein said first leg comprises a pair of contact portions and said second leg comprises a pair of contact portions.

4. The door storage device of claim 1, wherein said first leg is longer than said second leg.

5. The door storage device of claim 4, wherein said protrusion extends outwardly from said first leg.

6. The door storage device of claim 1, wherein said protrusion is removable from said legs.

7. The door storage device of claim 1, wherein said first leg comprises said protrusion and said second leg comprises said protrusion.
